(19) United States
(12) Patent Application Publication
(10) Pub. No.: US 2005/0190660 A1
(43) Pub. Date: Sep. 1, 2005

(54) Library for storing and retrieving removable information storage elements

(76) Inventors: Duncan Wakelin, Bristol (GB); Ian Peter Crighton, Bristol (GB); Rhys Wyn Evans, Wales (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/044,418

(22) Filed: Jan. 27, 2005

(30) Foreign Application Priority Data
Jan. 30, 2004 (GB) 0401987.3

(51) Int. Cl. G11B 7/085

(52) U.S. Cl. 369/30.27

(57) ABSTRACT

A library for storing and retrieving removable information storage elements such as tape cartridges that uses unique identifiers of the removable information storage elements stored in non-volatile memory in order to generate a cartridge map.

### TECHNICAL FIELD

The present invention relates to the field of automated storage and retrieval systems, also known as libraries.

### CLAIM TO PRIORITY

This application claims priority to copending United Kingdom utility application entitled, “A LIBRARY FOR STORING AND RETRIEVING REMOVABLE INFORMATION STORAGE ELEMENTS,” having serial no. GB 0401987.3, filed Jan. 30, 2004, which is entirely incorporated herein by reference.

### BACKGROUND

In an automated information storage and retrieval system, also known as a library, numerous slots, or storage cells, are provided within the library. These storage cells are used to hold information media that are portable or removable from the library, such as magnetic tape cartridges or optical disks.

The term “cartridge” used herein refers to any retaining structure for such removable information media. The storage cells typically have an opening in the front to allow the cartridge to be inserted or removed.

A library typically includes a controller, an accessor, a drive, and an Input/Output station. The library controller directs the actions of the other library components. The library controller can also connect to a host processor and respond to control commands from the host processor. The library controller inventories the storage cells noting the identity of each cartridge occupying a storage cell. If no cartridge is situated in a particular storage cell, the library controller records this storage cell as empty. Typically, each cartridge has a unique identifying mark, such as a bar code label, on an edge of the cartridge visible through the cell opening.

The accessor transports a selected cartridge between its origin and its destination. A storage cell, a drive, and the Input/Output station serve as origins and/or destinations. The accessor grips the cartridge with a holding device. The accessor may also be equipped with a vision system, such as a bar code reader, to read the label on a storage cell when the accessor is positioned near the storage cell.

During an inventory of the library, such as when the library is reset, the vision system scans the cells and reports to the library controller the identity of stored cartridges and their location within the array of storage cells. The library controller records the identity and location information in a database in order to create a cartridge map. The library controller later refers to and updates this cartridge map when a cartridge is moved between an origin and a destination. In this sense, the library controller must “know” the identity of each cartridge and its location within the array of cells in order to be able to retrieve the cartridge for access.

Libraries also have one or more drives to read data from a tape cartridge or write data to a tape cartridge. The accessor removes a selected tape cartridge from a storage cell and inserts it into the drive. Once in the drive, data can be read from the tape cartridge and sent to the host processor.

In some library configurations, the data is sent to the host processor through the library controller. Whereas, in other library configurations the data is transferred directly from the drive to the host processor. In this latter configuration, the library controller sends a response to the host processor indicating the selected cartridge is placed in the drive.

The host processor then issues a command to the drive to transfer the data. Likewise, data can be written from the host processor to the drive in either library configuration. In both configurations, the library controller directs the accessor to load the selected cartridge into the drive before the data is written to the cartridge.

Libraries also typically include an Input/Output station and an operator panel. The Input/Output station is a port through which a system operator can pass a cartridge to be added to the storage array or through which the accessor can pass a cartridge to the operator for removal from the storage array. The operator panel provides a communication mechanism for an operator to make requests to add cartridges to the library or remove cartridges from the library. The Input/Output station allows the operator to change cartridges in the storage array without requiring the library controller to inventory the entire storage array. Typically, an inventory must be taken each time a library access door is opened by the operator since it is not known whether the operator has added cartridges to the array, has removed cartridges from the library, or has not altered the contents of the library at all.

As stated before, an inventory-of the library may require the vision system of the accessor to scan all the storage cells in the storage array and report to the library controller the identity of stored cartridges and their location within the array of storage cells. If a cartridge label cannot be detected or read when the accessor is near a storage cell, that cell is recorded as empty.

The vision system may also mistakenly classify a cell as being empty when, in fact, the cell is actually occupied. For example, a cartridge may occupy the cell but have an unreadable label, or even no label. A cartridge may be improperly oriented within the cell or a foreign object may occupy the cell. If the accessor attempts to insert a cartridge into such an occupied cell, an error condition will result causing a time consuming error recovery procedure to be initiated.

One known error procedure attempts to reduce such non-empty errors by directing the accessor's gripper to attempt to reach inside every cell which does not have an identifiable cartridge and verify by “touch” that the cell is actually empty. Any cell which is still not found to be empty is classified in the database as having an “occupied but invalid” status to prevent its use. An inventory of a 400 cell library, for example, can take three or four hours to complete using this procedure.

Examples for such libraries of the above described types are disclosed in U.S. Pat. Nos. 6,512,963; 5,581,522; 5,059,772; 6216,057; 5761,161.

### SUMMARY

The present invention provides a library for storing and retrieving removable information storage elements. One embodiment is a library for storing and retrieving removable information storage elements, each of the removable information storage elements having a non-volatile memory in which a unique identifier is stored, the library comprising: a plurality of storage cells for storing the removable information storage elements, at least one drive for reading information from the removable information storage elements, an accessor for transporting the removable information storage elements between the storage cells and the at least one drive, a data reader apparatus for reading the unique identifiers from the non-volatile memories, and a controller operable to (a) direct the accessor to move one of the removable information storage elements from its storage cell to the at least one drive, (b) direct the data reader apparatus to read the unique identifier from the non-volatile memory of the one of the removable information storage elements, and (c) enter the unique identifier into a cartridge map identifying locations in the library of the removable information storage elements.

Another embodiment is a method of inventorying a library for storing and retrieving removable information storage elements, each of the removable information storage elements having a non-volatile memory in which a unique identifier is stored, the method comprising sequentially moving the removable information storage elements from storage cells to a drive unit for reading of the unique identifiers, and storing the unique identifiers in the library to provide a cartridge map.

### BRIEF DESCRIPTION OF THE DRAWINGS

In the following preferred embodiments of the invention will be described in greater detail, by way of example only, with reference to the drawings in which:

FIG. 1 is a block diagram of a library,

FIG. 2 is illustrative of a method of making an inventory of the library of FIG. 1.

### DETAILED DESCRIPTION

Embodiments provide a library for storing and retrieving removable information storage elements. The removable information storage elements have non-volatile memories for storing of unique identifiers. The library has storage cells for storing the removable information storage elements and at least one drive for reading information from the removable information storage elements. An accessor is used for transporting the removable information storage elements between the storage cells and the at least one drive.

In one embodiment, at least one drive has a data reader for reading of the unique identifier from the non-volatile memory. Further, the library has a controller that is operable to direct the accessor to move one of the removable information storage elements from its storage cell to the at least one tape drive, to direct the data reader to read the unique identifier, and to enter the unique identifier into a cartridge map.

One advantage provided by the various embodiments is that storage of the unique identifiers of the removable information storage elements in the non-volatile memory can reduce or avoid a need for an optical bar code reader for reading of bar code labels attached to the removable information storage elements. A further advantage is that using non-volatile memory rather than bar code labels can reduce or avoid mechanical wear and tear to which the prior art bar code labels are subject. This facilitates more reliable operation of the library, as interruptions which occur in prior art library systems when a bar code label becomes unreadable or is lost can be reduced or eliminated.

In accordance with one embodiment, the storage cells are arranged in an array.

In accordance with an embodiment, the controller of the library is operable to inventory the storage cells by directing the accessor and the at least one drive to sequentially read all the unique identifiers of the removable information storage elements stored in the storage cells. This way a cartridge map is provided that maintains information on where the removable information storage elements are located in the storage cells.

In accordance with a further embodiment, the removable information storage elements are tape cartridges and the library is a tape library for storing and retrieving tape cartridges. For example, the library implements the linear tape-open (LTO) technology. LTO technology is an ‘open format’ technology, which means that users can have multiple sources of media and compatible tape drives. The ULTRIUM form at is the ‘high capacity’ implementation of LTO technology. A LTO compliant cartridge has a non-volatile cartridge memory (LTO-CM) which is a memory chip embedded in the cartridge. It uses a radio frequency interface that eliminates the need for a physical power or signal connection between cartridge and tape drive. The LTO-CM is used for storing information which in other tape formats may be stored in the header at the beginning of the tape.

In accordance with a further embodiment, invention the cartridge memory is used for storing of the unique identifier of the tape cartridge. Alternatively or in addition a predefined tape location is used for storing the unique identifier.

In accordance with an embodiment, globally unique identifiers are used for identification of the removable information storage elements. The globally unique identifiers for the removable information storage elements can be generated by means of known prior art methods. For example UUIDs (Universally Unique IDentifiers) can be used as globally unique identifiers.

A UUID is an identifier that is unique with respect to the space of all UUIDs. A UUID can be used for multiple purposes, from tagging objects with an extremely short lifetime, to reliably identifying very persistent objects across a network.

The generation of LUIDs does not require a registration authority for each single identifier. Instead, it requires a unique value over space for each UUID generator. This spatially unique value is specified at an IEEE 802 address, which is usually already applied to network-connected systems. This 48-bit address can be assigned based on an address block obtained through the IEEE registration authority. This UUID specification assumes the availability of an IEEE 802 address (http://www.opengrouip.org/onlinepubs/9629399/apdxa.htm), incorporated by reference herein. This specification also contains algorithms for UTID generators.

Methods for generating globally unique identifiers are also described in ‘UUIDs and GUIDs’, Leach, Paul J.; Salz, Rich network working group—internet draft available on, http://hegel.ittc.ukans.edu/topics/internet/internet-drafts/draft-1/draft-leach-uuids-guids-01.txt, incorporated by reference herein.

It is. However. important to note that the various embodiments are not limited as to the method employed for generating the globally unique identifiers. As a matter of principle, any system or method that provides such globally unique identifiers can be used. Preferably, a globally unique identifier that has been generated for a removable information storage element is stored in the non-volatile memory of that removable information storage element by the manufacturer of the removable information storage element.

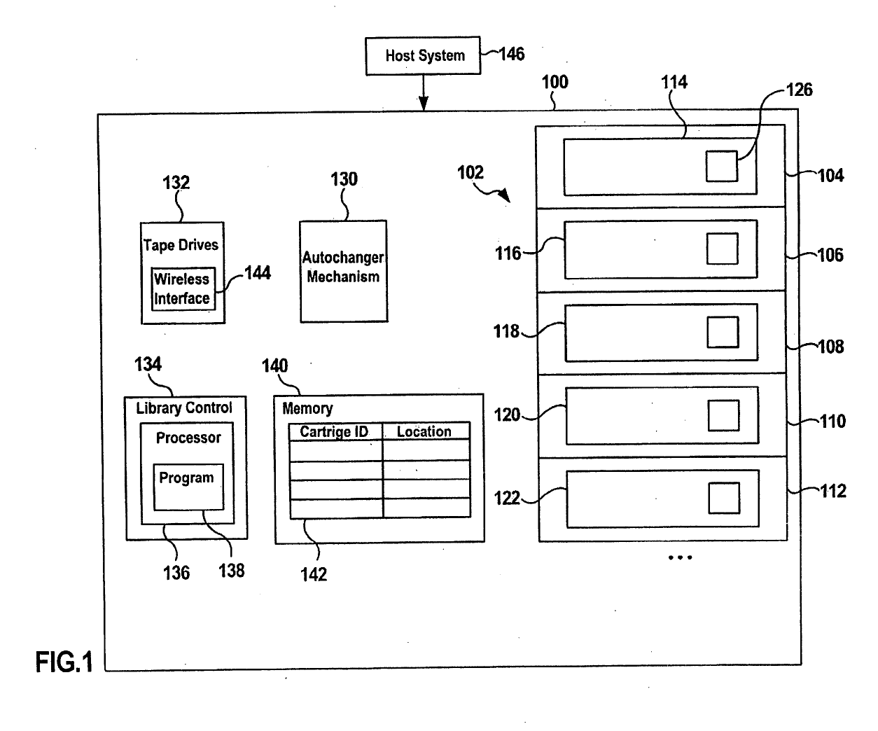

FIG. 1 shows a tape library 100 that has an array 102 of storage cells 104, 106, 108, 110, 112, . . . . Tape cartridges 114, 116, 118, 120, 122, . . . are stored in respective storage cells 104, 106, 108, 110, 112, . . . . Each of the tape cartridges 114, 116, . . . has a cartridge memory (CM) 126. Cartridge memory 126 is a non-volatile memory for storing information. Each of the tape cartridges 114, 116, . . . has an assigned globally unique identifier that is stored in the cartridge memory 126 of that tape cartridge.

An accessor 130 provides an autochanger mechanism for transportation of a selected one of the tape cartridges 114, 116, . . . between its storage cell and a tape drive unit 132. For example, the accessor 130 includes a gripper for holding the cartridge. Operation of accessor 130 and tape drive unit 132 is controlled by a library controller 134. The library controller 134 has a microprocessor 136 for running a computer program 138. Library controller 134 is coupled to a memory 140 for storage of a table 142 as well as for updating and reading data from the table 142. Table 142 provides a cartridge map that identifies one of the storage cells for each of the tape cartridges loaded in the library.

Tape drive unit 132 has a wireless interface 144 in order to read data from the cartridge memories. A host system 146 is coupled to the tape library 100 for storing backup data and/or for the purpose of data recovery.

In operation, array 102 is loaded with tape cartridges 114, 116, 118, . . . . This can be done manually by an operator or by means of an input/output station that allows an operator to add or remove cartridges to the library 100 without opening a locking front door (not shown) of library 100.

Closing the locking front door invokes the program 138 in order to perform an inventory of library 100. Program 138 directs accessor 130 to sequentially move tape cartridges 114, 116, 118, . . . from the array 102 to tape drive unit 132 in order to read out the respective globally unique identifiers of the tape cartridges from their respective cartridge memories 126. The location of a tape cartridge in array 102, i.e. storage cell array coordinates for the tape cartridge, together with the tape cartridge ID, i.e. the unique identifier of the tape cartridge, are entered into table 142. After all of the tape cartridges loaded in array 102 have been processed this way table 142 provides a complete cartridge map in that the table 142 identifies the storage cell of each loaded tape cartridge.

Tape library 100 does not require bar code labels on the tape cartridges. Thus, no optical bar code label reader is required. Another advantage is increased reliability and reduced system down time in comparison to prior art tape libraries that rely on bar code labels. This is due to the fact that the cartridge memories 126 are not subject to the mechanical wear and tear to which the prior art bar code labels are subject. In particular a cartridge memory 126 has a greatly reduced risk of becoming unreadable or being lost, even after numerous read operations and inventories.

In addition to tape drive unit 132 an input/output station of the library 100 can also have a wireless interface 144 in order to read the unique identifier of a new tape cartridge that is added. The unique identifier is reported from the input/output station to the library controller 134 for updating of the library of table 142.

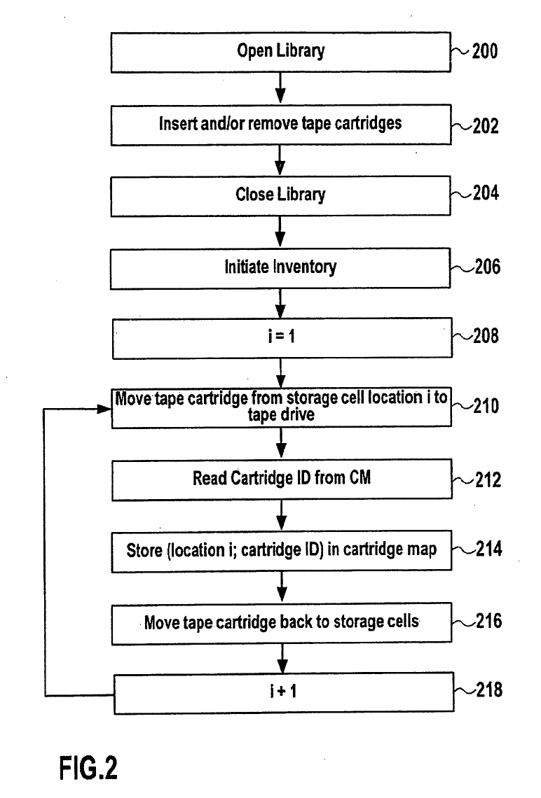

FIG. 2 is a corresponding flow chart showing operation of the library 100. In step 200 the library is opened by a user. In step 202 tape cartridges are inserted and/or removed from the tape library. In step 204 the library is closed. Closing of the library initiates making of an inventory in step 206. In step 208 and array index i is initialised. In the example considered here the index is one dimensional; in other implementations the array index is two dimensional.

In step 210 a tape cartridge that is stored in storage cell i of the array is moved to the tape drive unit. In step 212 the unique cartridge identifier (ID) is read from the cartridge memory by means of the tape drive unit's wireless interface. The array index i and its assigned unique cartridge ID are stored in the library in order to provide a cartridge map in step 214.

In step 216 the tape cartridge is moved back from the tape drive unit to the array. In step 218 the index i is incremented and the control goes back to step 210 in order to process the tape cartridge that is stored in the consecutive storage cell in the array. This procedure goes on until all storage cells of the array have been examined. As a result a complete cartridge map is provided that forms the basis for the following data backup and/or recovery operations.

### LIST OF REFERENCE NUMERALS

100
Tape Library
102
Array
104
Storage Cell
106
Storage Cell
108
Storage Cell
110
Storage Cell
112
Storage Cell
114
Tape Cartridge
116
Tape Cartridge
118
Tape Cartridge
120
Tape Cartridge
122
Tape Cartridge
126
Cartridge Memory
130
Accessor
132
Tape Drive Unit
134
Library Controller
136
Microprocessor
140
Computer Program
142
Table
144
Wireless Interface
146
Host System

1. A library for storing and retrieving removable information storage elements, each of the removable information storage elements having a non-volatile memory in which a unique identifier is stored, the library comprising:
a plurality of storage cells for storing the removable information storage elements,
at least one drive for reading information from the removable information storage elements,
an accessor for transporting the removable information storage elements between the storage cells and the at least one drive,
a data reader apparatus for reading the unique identifiers from the non-volatile memories, and
a controller operable to:
(a) direct the accessor to move one of the removable information storage elements from its storage cell to the at least one drive,
(b) direct the data reader apparatus to read the unique identifier from the non-volatile memory of the one of the removable information storage elements, and
(c) enter the unique identifier into a cartridge map identifying locations in the library of the removable information storage elements.

2. The library of claim 1, the controller being operable to inventory the storage cells by performing the steps (a) to (c) for all removable information storage elements stored in the storage cells.

3. The library of claim 1, the removable information storage elements being tape cartridges.

4. The library of claim 1, the non-volatile memory being a predefined storage location on the removable information storage element.

5. The library of claim 1, the non-volatile memory being an integrated circuit memory component.

6. The library of claim 1, the non-volatile memory being a cartridge memory.

7. The library of claim 1, the data reader apparatus having a wireless interface for reading the non-volatile memory.

8. A method of inventorying a library for storing and retrieving removable information storage elements, each of the removable information storage elements having a non-volatile memory in which a unique identifier is stored, the method comprising:
sequentially moving the removable information storage elements from storage cells to a drive unit for reading of the unique identifiers, and
storing the unique identifiers in the library to provide a cartridge map.

9. The method of claim 8, the removable information storage elements being tape cartridges.

10. The method of claim 8, wherein a predefined storage location of the removable information storage elements is used as the non-volatile memory.

11. The method of claim 8, wherein an integrated circuit memory component is used as the non-volatile memory.

12. The method of claim 11, wherein the integrated circuit memory component is a cartridge memory.

13. The method of claim 8, wherein a wireless interface is used for reading of the unique identifiers from the non-volatile memories.

14. The method of claim 8, wherein moving the removable information storage elements further comprises moving tape cartridges.

15. The method of claim 8, fiurther comprising using the non-volatile memory as a predefined storage location of the removable information storage elements.

16. The method of claim 8, performing an inventory of the storage cells for all removable information storage elements stored in the storage cells.

17. The method of claim 16, wherein performing the inventory fiurther comprises:
directing an accessor to move one of the removable information storage elements from its storage cell to the at least one drive;
directing a data reader apparatus to read the unique identifier from the non-volatile memory of the one of the removable information storage elements; and
entering the unique identifier into a cartridge map identifying locations in the library of the removable information storage elements.

18. A program for storing and retrieving removable information storage elements, the program stored on computer-readable medium and comprising logic configured to perform:
sequentially moving the removable information storage elements from storage cells to a drive unit for reading of the unique identifiers, and
storing the unique identifiers in the library to provide a cartridge map.

19. An apparatus for storing and retrieving removable information storage elements, each of the removable information storage elements having a non-volatile memory in which a unique identifier is stored, the apparatus comprising:
means for sequentially moving the removable information storage elements from storage cells to drive means in order to read the unique identifiers, and
means for storing the unique identifiers to provide a cartridge map.

20. The apparatus of claim 19, further comprising an input/output station for adding and removing the unique identifiers from the storage cells, the input/output station comprising means for reading the unique identifier of one of the removable information storage elements that is added and means for updating the cartridge map.
